(19) United States
(12) Patent Application Publication
(10) Pub. No.: US 2015/0369351 A1
(43) Pub. Date: Dec. 24, 2015

(54) PUMPING DEVICE

(71) Applicant: Voith Patent GmbH, Heidenheim (DE)

(72) Inventors: Andreas Hermann, Neuler (DE); Volker Middelmann, Crailsheim (DE); Reinhard Kernchen, Satteldorf (DE); Hans Schirle, Stimpfach (DE)

(73) Assignee: Voith Patent GmbH, Heidenheim (DE)

(21) Appl. No.: 14/746,140

(22) Filed: Jun. 22, 2015

(30) Foreign Application Priority Data
Jun. 23, 2014 (DE) 102014211964.2

(51) Int. Cl. F16H 41/24; F16H 41/30

(52) U.S. Cl. CPC F16H 41/24; F16H 41/30

(57) ABSTRACT

The invention relates to a pumping device for introduction of a fluid into a base layer, in particular into a base layer containing gas, for the production of gas-permeable structures in the base layer. The pumping device is arranged on a transportation vehicle having a separate drive unit, including a pump motor and a pump, whereby a speed/torque converter is arranged between pump and pump motor. A hydrodynamic device, in particular a hydrodynamic converter, is used in place of a transmission for speed/torque conversion.

### BACKGROUND OF THE INVENTION

1. Field of the Invention

The invention relates to a pumping device for introduction of a fluid into a base layer, in particular into a base layer containing gas, for the production of gas-permeable structures in the base layer, wherein the pumping device is arranged on a transportation vehicle having a separate drive unit.

2. Description of the Related Art

Shale gas is obtained through “hydraulic fracturing,” often referred to as “fracking”. To allow base layers to deliver the gas it is necessary that the base layers possess cracks through which the gas can escape. To produce artificial cracks, guide bores are created through which then a fluid is forced into the surrounding base layer under very high pressure (up to 1500 bar), so that gas permeable structures are produced all around the drill string. The fluid, referred to as “frac fluid,” consists generally of water, sand, and chemicals. As a rule the pumping devices thus employed are arranged on a transportation vehicle having a separate drive unit so that they can be easily transported from one drill hole to another.

Such a pumping device which is used almost exclusively today generally includes an internal combustion engine, diesel engine or gas engine, a multi-speed transmission, and a pump. The pump may be a plunger or a piston pump. The transmission is essentially an automatic transmission with up to 8 gears whereby the load upon the gears, due to the special mode of operation during fracking, is distributed unevenly over the gears, thus resulting in load peaks in particular during ramping up of the pumping device.

An additional and substantially greater problem is the vibration load in the drive train of these pumping devices. This is substantially caused by the pump and can in addition be intensified by an internal combustion engine. It has been shown that the alternating torques resulting from the torsional vibration are of such a magnitude during operation of such a drive train that high wear and tear results, as well as a regular occurrence of transmission damage, resulting in having to replace the transmission. To avoid this, relatively short maintenance intervals are necessary.

What is needed in the art is a pumping device which does not have the aforementioned disadvantages.

### SUMMARY OF THE INVENTION

The present invention provides a pumping device having a hydrodynamic device, in particular a hydrodynamic converter arranged between the pump and the pump motor. The use of a hydrodynamic converter provides substantial advantages for operational reliability and operational mode of the pumping device. The use of a hydrodynamic converter also renders a mechanical multi-gear transmission between the drive motor and pump redundant. The speed and torque of the output adjust continuously, automatically, and without torque interruption, depending on the drive status. With a drive motor which is variable in engine load and engine speed, a hydrodynamic converter without turbine vane adjustment is generally sufficient. Moreover, a vibration decoupling of pump motor and pump occurs, leading to an extension of the operating life of all components and to a reduction in maintenance requirements.

Even at low speeds, high torques can be transferred via the converter, whereby in particular the start-up behavior of the pump is substantially improved. When the converter is emptied the pump motor can moreover be brought completely load free to operational speed. In the case of an emergency, the converter can be emptied very quickly via a quick emptying device, providing an emergency stop function, whereby the pump and pump motor are decoupled from each other.

In one embodiment of the invention, the hydrodynamic converter is directly flange mounted onto the drive motor. Alternatively, a cardan shaft connection between drive motor and converter may be provided. The pump may be connected via a cardan shaft with the converter. The converter may be designed as a single stage converter or as a multi-stage converter. The type of converter used will substantially depend on the required type of operation or respectively the required performance. In another embodiment of the invention, a hydrodynamic converter with adjustable guide vanes is used. This is advantageous in particular if engine characteristics upgrading, such as load range and speed range is required, or if the engine characteristic is limited by a drive motor running at a constant speed.

The hydrodynamic converter has a cooling circuit for cooling of the operating fluid, typically oil. This cooling circuit can be connected with the cooling circuit of the drive motor and/or the cooling circuit of the engine of the transportation vehicle. The required cooling performance can thereby be better adjusted to the requirements. The design of the individual cooling circuits can moreover be smaller, so that the sum total of the necessary space requirement on the transportation vehicle is reduced. In one advantageous embodiment of the invention, the hydrodynamic converter can also have a separate cooling circuit and can be operated independently.

In an additional advantageous embodiment of the invention, the drive motor can be an electric drive motor. By using an electric drive motor in combination with a hydrodynamic converter, use of a frequency converter can be foregone. In combination with a guide vane adjustment, the engine characteristics can be expanded.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a pumping device according to the current state of the art;

FIG. 2 shows a pumping device with hydrodynamic converter;

FIG. 3 shows a pumping device with flange-mounted hydrodynamic converter; and

FIG. 4 shows cooling circuit.

Corresponding reference characters indicate corresponding parts throughout the several views. The exemplifications set out herein illustrate embodiment of the invention, and such exemplifications are not to be construed as limiting the scope of the invention in any manner.

### DETAILED DESCRIPTION OF THE INVENTION

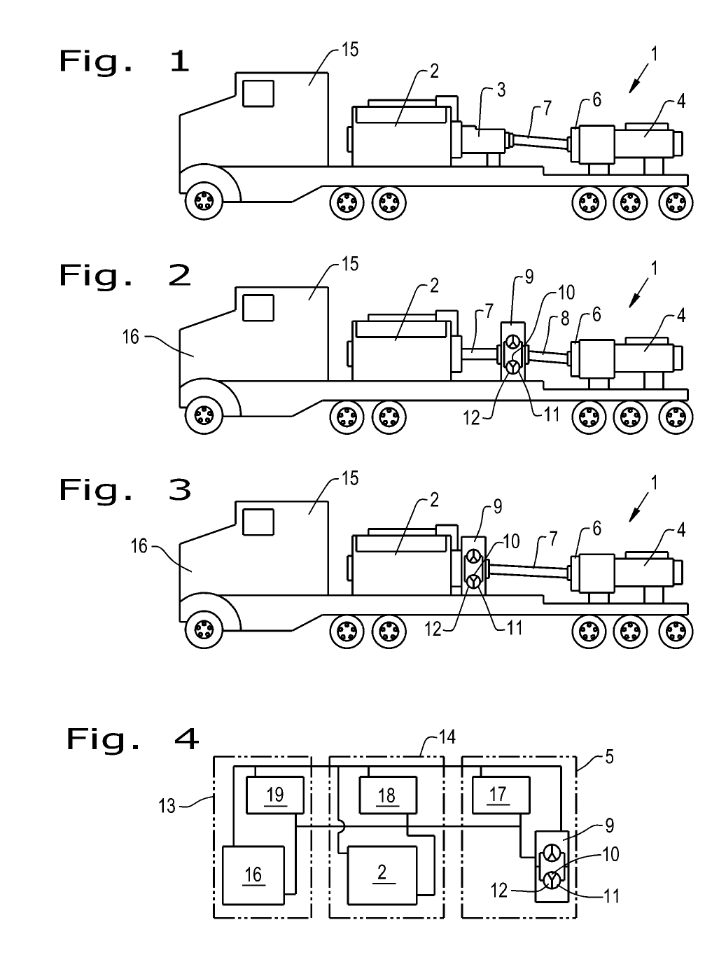

FIG. 1 shows a pumping device 1 according to the current state of the art. Pumping device 1 includes a pump motor 2, an automatic transmission 3, and a pump 4. Pump 4 is connected via a cardan shaft 7 with automatic transmission 3, whereby pump 4 may have an additional integrated transmission 6.

FIGS. 2 and 3 show a pumping device 1 with a hydrodynamic converter 9 according to the invention. Pumping device 1 is arranged on a transport vehicle 15 having a separate drive unit 16. The designs in FIGS. 2 and 3 essentially differ in that the converter 9 in FIG. 2 is not flange mounted directly on drive motor 2, but is instead connected via a drive shaft 7 with the drive motor 2.

With hydrodynamic converters or also hydrodynamic transmissions according to the Fottinger principle the power transfer between pump and turbine wheel occurs through the inertia force of the operating fluid. The stationary guide wheel hereby absorbs the difference which occurs depending upon operational condition between drive torque and output torque and thus enables a torque conversion. The drive motor is put under load only with increasing drive speed. The drive torque is greatest during standstill of the drive shaft, usually at start-up and decreases with increasing speed. The drive speed thus adjusts continuously and automatically to the present resistance. In other words, the drive speed is low during the greatest resistance that has to be overcome and high during low resistance. The drive shaft can also be reliably locked with the running engine. The torques are essentially produced by inertia forces which result from speed changes of the fluid stream in the converter circuit and thus offer excellent vibration damping and shock absorption.

The entire drive performance is produced by internal combustion engine 2, the so-called power-pack units. The power transfer to pump 4, which may be a plunger or a piston pump, occurs via converter 9 without an additional gear stage or switching steps and transmission ratios. During pumping the speed must be able to be adapted continuously and ideally without torque interruption to the required pump performance.

Due to geological conditions strong pressure fluctuations may occur during pumping, which lead to shock and torque fluctuations in the pump. The interconnected converter 9 can absorb these, thereby considerably increasing the service life of the engine 2 and that of the additional drive train components. Utilization of a single stage converter is generally sufficient. It is however moreover conceivable to use a multi-stage converter. Single stage as well as multi-stage converters can be combined with guide vane adjustment. The hydrodynamic converter 9 includes a pump wheel 12, a turbine wheel 11, and a stationary or adjustable guide wheel 10. These vane-equipped wheels, together with the converter housing form the oil-filled hydrodynamic circuit. In the embodiment shown in FIG. 2 pump wheel 12 is coupled directly via drive shaft 7 with an engine 2, and turbine wheel 11 is coupled directly via drive shaft 8 with the pump 4 or integrated transmission 6 thereof. There is no mechanical connection between pump wheel 12, turbine wheel 11, and stationary guide wheel 10. The converter circuit is filled permanently with oil and is kept under pressure during operation by the motor-side driven geared pump.

FIG. 4 shows a cooling circuit 5 provided for the removal of the excess heat loss. Cooling circuit 5 may be a separate cooling circuit or can alternatively be coupled with cooling circuit 14 of pump motor 2 of pumping device 1 and/or with cooling circuit 13 of the engine of transportation vehicle 15. FIG. 4 further illustrates cooling circuits 13, 14, 5 of motors 16, 2 and of converter 9 and their possible coupling. Only the basic connection of individual cooling circuits 5, 13, 14 is shown, without the associated pumps, valves and other necessary components for the technical conversion and adjustment of the individual cooling circuits. Cooling circuit 13 is provided with vehicle engine radiator 19. Cooling circuit 14 is provided with pump motor radiator 18. Cooling circuit 5 is provided with radiator converter 17. Converter 9 is shown having pump wheel 12, turbine 11, and stationary guide wheel 10. While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.
1 Pumping device
2 pump motor
3 automatic transmission
4 pump
5 cooling circuit
6 integrated transmission
7 drive shaft
8 drive shaft
9 hydrodynamic converter
10 guide wheel
11 turbine wheel
12 pump wheel
13 cooling circuit
14 cooling circuit
15 transportation vehicle
16 engine
17 radiator converter
18 radiator pump motor
19 radiator vehicle engine

What is claimed is:

1. A pumping device for introduction of a fluid into a base layer for the production of gas-permeable structures in the base layer, comprising:
a pumping device arranged on a transportation vehicle having a separate drive unit;
said pumping device having a pump motor, a pump, and a speed/torque converter arranged between said pump and said pump motor; and
said speed/torque converter being a hydrodynamic converter.

2. The pumping device according to claim 1, wherein:
said speed/torque converter is flange mounted directly on said pump motor.

3. The pumping device according to claim 1, wherein:
said pump is connected with said speed/torque converter through a cardan shaft.

4. The pumping device according to claim 1, wherein:
said hydrodynamic converter is one of a single stage converter and a multi-stage converter.

5. The pumping device according to claim 1, wherein:
said hydrodynamic converter is equipped with adjustable guide vanes.

6. The pumping device according to claim 1, wherein:
said hydrodynamic converter is equipped with a first cooling circuit that is connected with at least one of:
a second cooling circuit of said pump motor; and
a third cooling circuit of an engine of said transportation vehicle.

7. The pumping device according to claim 1, wherein:
said pump motor is an electric motor.
